(19) United States
(12) Patent Application Publication
(10) Pub. No.: US 2013/0119030 A1
(43) Pub. Date: May 16, 2013

(54) METHOD AND APPARATUS FOR HEAT TREATING THE WAFER-SHAPED BASE MATERIAL OF A SOLAR CELL, IN PARTICULAR A CRYSTALLINE OR POLYCRYSTALLINE SILICON SOLAR CELL

(71) Applicant: Paul Alexander Harten, Essen (DE)

(72) Inventor: Paul Alexander Harten, Essen (DE)

(73) Assignee: LIMO PATENTVERWALTUNG GMBH & CO. KG, Dortmund (DE)

(21) Appl. No.: 13/576,464

(22) PCT Filed: Feb. 3, 2011
(86) PCT No.: PCT/EP11/95560

§ 371 Date: Jan. 31, 2013

(30) Foreign Application Priority Data
Feb. 3, 2010 (DE) 10 2010 006 654.0

(51) Int. Cl. B23K 26/00

(52) U.S. Cl. CPC B23K 26/0066
USPC 219/121.85; 219/121.6

(57) ABSTRACT

A method and an apparatus for heat treating a wafer-shaped base material of a solar cell, in particular of a crystalline or polycrystalline silicon solar cell, wherein the device comprises at least one laser light source (4a, 4b).

The present invention relates to a method of heat treating the wafer-shaped base material of a solar cell, in particular of a crystalline or polycrystalline silicon solar cell, according to the preamble of claim 1. Furthermore, the present invention relates to an apparatus for heat treatment of the wafer-shaped base material of a solar cell, in particular of a crystalline or polycrystalline silicon solar cell, according to the preamble of claim 8.

The underlying object of the present invention is to provide a method of the aforementioned type and to provide an apparatus of the aforementioned type which is more effective and/or less expensive.

These objects are solved with respect to the method by a method of the aforementioned type with the characterizing features of claim 1 and with respect to the apparatus by an apparatus of the aforementioned type with the characterizing features of claim 8. The dependent claims relate to preferred embodiments of the invention.

Many quite differently constructed types of solar cells exist. This application is particularly concerned with crystalline and polycrystalline silicon solar cells. These are uniformly thick square silicon wafers with dimensions H×W×D (typically):

H=80 . . . 220 μm×W=125 . . . 210 mm×T=125 . . . 210 mm.

The problem to be solved addresses the heat treatment of this type of solar cells for baking out solvents and immediately thereafter indiffusing dopants as well as simultaneously diffusing and sintering of metalized surfaces. The present state of the art for heat treatment employs continuous furnaces having a length of about 10 m and a width of approximately 1 m (approx. 10 sq.m. floor area) and an electrical power input of up to 100 kW. For the proposed solution in this application using lasers, an order of magnitude less floor area and an order of magnitude less power input would be required.

The heat treatment of this type of solar cells is a complex matter, because a number of interdependent processes take place in succession, which however sometimes also operate in parallel and overlap, in a time-continuous and complex heating profile. These processes all have a strong effect on the efficiency of the solar cell and significantly affect the economic viability of the solar cell.

Currently, the stated goal of the manufacturers of this type of solar cells is to achieve a cycle time of one second. This means that a finished solar cell should leave production every second. To realize this cycle time cost-effectively, processes which scan the solar cell in a raster pattern (scan method) are less suitable due to the slower processing speed. More advantageous are those methods where the entire solar cell is processed simultaneously. This simultaneous illumination can be spatially very precisely adjusted with various arrangements of homogenized laser diodes or laser diode bars (free-space radiators or fiber-coupled modules). The precision in the illumination enables a geometrically precise illumination of the solar cell so that all the light is used for illumination and heating (spatial precision, energy efficiency).

In the past, experiments were conducted for the rapid simultaneous optical heat treatment of cells with flashlights. Analogous to the established process used in the semiconductor production, these tests were performed under the generic term “RTP” (Rapid Thermal Processing) which is well-known in the semiconductor industry.

The experiments have shown that although RTP promises some technical advantages, RTP was unable to outperform the continuous furnaces in key aspects, such as throughput and process costs. Therefore, RTP is currently not employed in any mass production of solar cells. These barriers can be overcome through the use of homogenized laser diode arrays: their modulatability in the μs range provides sufficient heating dynamics within one cycle period (1 s) (temporal precision). The power input of the laser solution which is lower by an order of magnitude is accompanied by correspondingly lower operating costs compared to the continuous furnace.

Another important constraint in the production of solar cells is the processing uniformity over the entire surface of the solar cell. Non-uniformities can thus reduce the efficiency of the solar cell and their economic viability (for example, uniform full-surface back-side contacting of the solar cell with indiffused aluminum paste). The uniform heating is an ongoing challenge with furnaces and flash lamp assemblies, because these heating mechanisms are subject to severe aging and therefore rely on constant calibration and readjustment. This disadvantage is eliminated in the present application by using precisely automatically controlled and homogenized laser diodes (spatial and temporal precision).

An edge effect can always be observed with dynamic heating with a variable temperature profile using furnaces or flash lamp assemblies, since even with exactly uniform heating the edges of the solar cell which conduct heat only over 180° heat up more than the inner regions which conduct heat over 360°. This non-uniform heating can be prevented by using specific non-uniform irradiation of the solar cell through precisely preset optical beam shaping, i.e., more intensity in the center and less intensity at the edge provide a uniform temperature distribution, even with a temporally variable temperature profile.

In addition to avoiding edge effects, beam shaping can be used for additional, targeted locally different heating profiles with predefined “hotter” and “colder” regions on the solar cell. (Example: interdigitated structures for contacting the front side of the solar cell).

A transparent holder of the solar cell made of quartz glass as part of the apparatus withstands high temperatures up to the melting point of silicon, and is also transparent to the diode laser light for heating the solar cell. The holder can simultaneously assume optical functions as part of the optical beam shaping for precisely controlled spatial illumination of the solar cell.

A complete laser heating system would include the following functional units:

1. Cell handling with input buffer,
2. Cell treatment (laser, beam shaping, cell holder, suction),
3. Output buffer with cell handling.
The system can thus be seamlessly integrated in the “flow” of modern in-line solar cell factories.

The apparatus is characterized by a ramp gradient of more than 100,000,000 K/s and hence offers an additional degree of freedom in the design of the process. This exceeds by far the state of the art using conventional furnaces with ramp gradients of several 100 K/s and was thus far unattainable. The advantage is a better control and modulatability of the temperature dependence for the heat treatment.

The high ramp gradient of the apparatus results from the operation of the 2^{nd} Functional unit (list functional units: see in the text above) of the apparatus, namely the cell processing (laser, beam shaping, cell holder, suction). The power supply to the laser with beam shaping is actually designed so that pulse control can be achieved with commercially available electronic pulse generators with rise and fall times of 10 μs and variable adjustable pulse durations (>10 μs) and variable pulse repetition rates.

The applicant has previously heated silicon wafers with similar laser sources with beam forming for chip production in its Applications Center, reaching a temperature difference of >1000 K within a heating duration of 10 μs. This results in a temperature gradient (ramp gradient) of 100,000,000 K/s

Initial limited progress and further developments in the field of high-current-short-pulse electronics with pulse durations in the nanosecond range will moist likely allow further reductions in pulse duration and the rise and fall times of commercially available power supplies for high power diode lasers.

It has already been investigated and shown In the Ph.D. thesis by Ji Youn Lee, Fraunhofer ISE, Freiburg, 2003, that long carrier lifetime and thus more efficient solar cells, in crystalline silicon solar cells, can be obtained with multiple RTP treatment. Multiple treatments can be expanded with the proposed apparatus, i.e. a greater number of rapid thermal processing steps can be realized within a shorter overall duration. Example: two repetitions of more than one second duration are described in the Ph.D. thesis Ji Youn Lee, Fraunhofer ISE, Freiburg, 2003. With the described apparatus, 1000 repetitions can be easily performed in one second. With a high number of fast temperature changes, other, as yet attainable material properties could be achieved.

Short temperature peaks (“spike anneal”) are already part of the current production technology in the production of semiconductor components (“chips”). However, this has been according to the author's knowledge so far not been studied in the manufacture of solar cells. The apparatus described herein allows development of new processes similarly to the conventional spike anneal used in the semiconductor industry also for the manufacture of solar cells so as to further increase the solar cell performance. An advantage of the spike anneal in the semiconductor component fabrication is the diffusion-free annealing of crystal defects. With the proposed apparatus, diffusion-free annealing of crystal defects could then also be used for solar cells.

With the proposed apparatus, the thermal treatment could be performed rapid successive steps. The step-wise increase or decrease of the temperature of the solar cell during the firing or drying process allows a more precise control over the heat treatment process.

It has been investigated and shown in the dissertation Ji Youn Lee, Fraunhofer ISE, Freiburg, 2003, that nonuniform illumination during the rapid oxidation process (“RTO”) leads to a non-uniform oxide thickness and hence to a nonuniform carrier lifetime and ultimately a non-uniform solar cell efficiency.

Uniform illumination is necessary because temperature variations of 10° C. during heating of the solar cell already produce clear differences in the electrical characteristic of the solar cell. 10° C. at a solar cell temperature of 1000° C. during the firing process represents a temperature variation of 1%. This results directly in the requirement that the variation of the illumination must also not be greater than 1% by taking into account the diffusion of the incident light energy in the silicon within the illumination time.

The non-uniformity is eliminated with an inventive apparatus. The illumination in the proposed apparatus is precisely adjusted through the micro-optical beam-shaped diode laser illumination which ensures a spatially uniform processing temperature and corresponding spatially uniform, mechanical, electrical and electro-optical properties of the solar cell (layer thicknesses, charge carrier lifetimes, cell efficiency).

In the following, embodiments of the present invention will be described in detail with reference to the accompanying drawings, which show in:

FIG. 1 a schematic perspective view of a first embodiment of an apparatus according to the present invention;

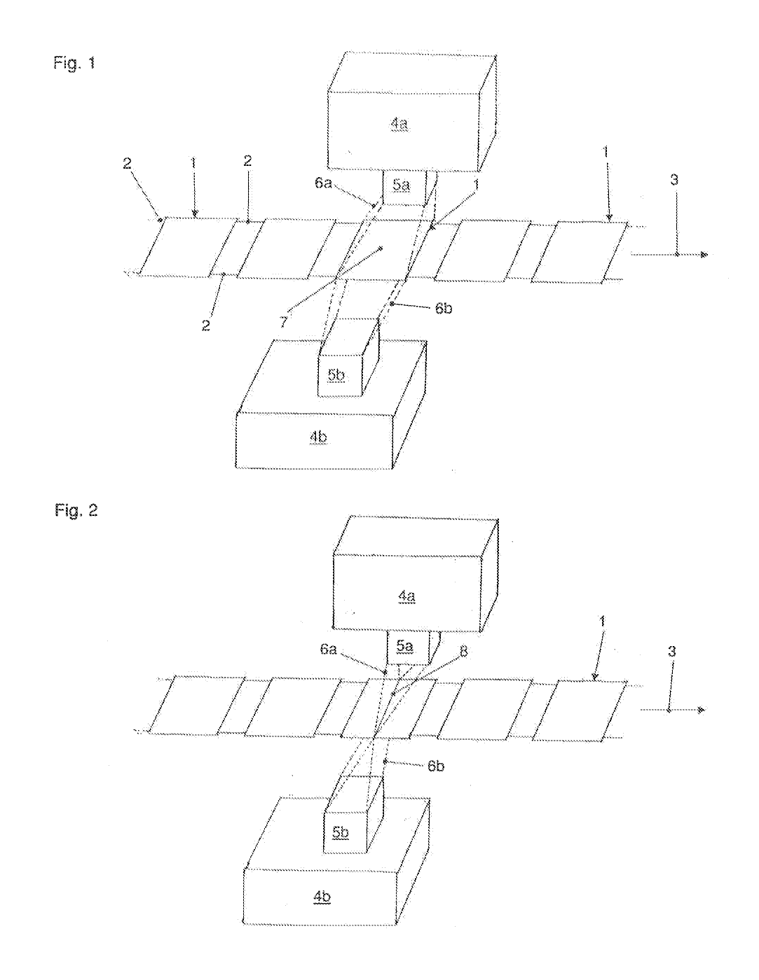

FIG. 2 a schematic perspective view of a second embodiment of an apparatus according to the present invention;

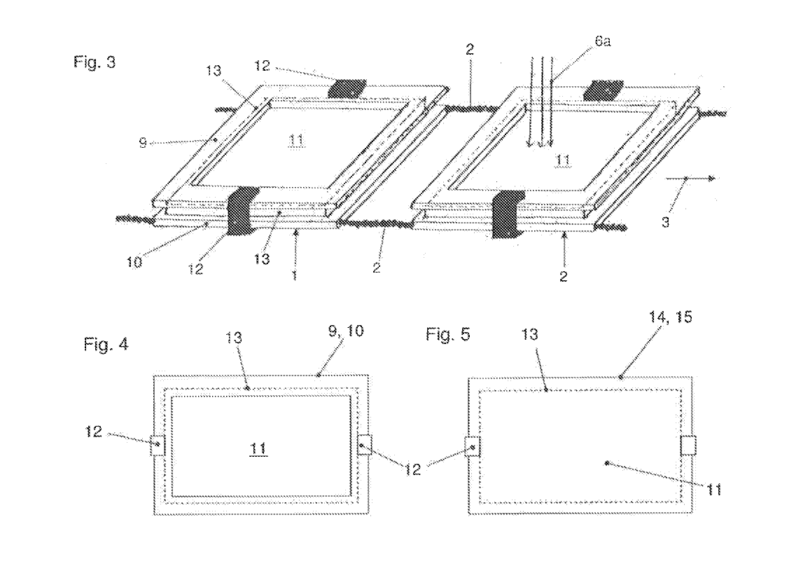

FIG. 3 a schematic perspective view of the holders of the base material of a solar cell;

FIG. 4 a plan view of one of the brackets as shown in FIG. 3; and

FIG. 5 a plan view corresponding to FIG. 4 of an alternative embodiment of a holder.

In the Figures, identical or functionally identical parts are shown with identical reference numerals.

The first embodiment of an apparatus according to the present invention shown in FIG. 1 includes a plurality of holders 1, which will be described hereinafter in more detail with reference to FIGS. 3 to 5. Each of the individual holders 1 holds one of the silicon wafers serving as a base material for a solar cell.

The individual holders 1 are connected with each other via suitable connecting means 2, allowing a plurality of interconnected holders 1 to be moved simultaneously in a transport device 3 to the right in FIG. 1.

The apparatus further includes two laser light sources 4a, 4b, which each include, for example, a respective laser diode or a plurality of laser diodes, in particular a laser diode bar or a stack of laser diode bars. For commercial reasons, the wavelength of the laser light source 4a, 4b may be in the range between 800 nm and 1100 nm. However, laser light sources 4a, 4b with longer wavelengths and in particular with shorter wavelengths may also be used.

The laser light sources 4a, 4b also include or can be connected with control means which control the operation of the laser light sources 4a, 4b, in particular their turn-on times or pulse durations. For example, pulse durations between 1 ns and 1 s may be employed.

The apparatus further includes schematically indicated first and second optical means 5a, 5b. Each of the optical means 5a, 5b includes homogenizers, which may include, for example, a plurality of in particular mutually crossed cylindrical lens arrays and a field lens. Each of the optical means 5a, 5b may also include lenses for beam shaping. The laser radiation 6a, 6b exiting the optical means 5a, 5b is indicated by dashed lines.

The first optical means 5a associated with the first laser light source 4a are designed so that the silicon wafers supported by the holders 1 are illuminated over the entire surface from above (see the exemplary top surface of the silicon wafer illuminated with a full-surface intensity distribution 6 of the holder 1 located below the first optical means). The second optical means 5b associated with the second laser light source 4b are designed so that the silicon wafers supported by the holders 1 are illuminated over the entire surface from below. The total exposure time should in particular not be longer than 1 s so as to maintain a cycle rate of 1 s.

The laser radiation 6a may be incident substantially perpendicular to the top side of the silicon wafer and the laser radiation 6b may be incident substantially perpendicular on the bottom side of the silicon wafer. Alternatively, the laser radiations 6a, 6b may also be each incident on the top side and/or the bottom side at an angle different from 0°.

In particular, a first laser radiation 6a may be applied to the top side of the silicon wafer and a second laser radiation 6b may be applied to the bottom side of the silicon wafer, wherein the first and second laser beams 6a, 6b may differ from each other with respect to one or more properties in order to initiate different processes in the top side and the bottom side of the silicon wafer serving as base material for a solar cell,

The pulse shape may be structured in time so that a preheating phase at a lesser intensity is followed by a potentially short phase at a higher intensity. A prolonged phase of lower intensity may then, for example, follow this phase of higher intensity so as to promote diffusion processes. The pulse shape may be provided repeatedly, so that the same pulse shape is identically available in the “in-line production line” for each passing silicon wafer. When the cycle time is 1 s, the pulse shape must therefore be repeated with a frequency of 1 Hz.

The transport of interconnected holders 1 in the transport direction 3 may be stopped during the illumination process. In this case, the laser light sources 4a, 4b together with the optical means 5a, 5b may be moved a distance in conjunction with the silicon wafer currently to be illuminated and then again returned before the next silicon wafer is illuminated.

The power density on the silicon surface may be selected to be approximately in a range between 0.1 and 30 kW/cm ^{2.}

Non-uniform heating of the silicon wafers may be prevented by ensuring an intentional, non-uniform irradiation of the solar cell which is precise preset by optical beam shaping. In particular, a greater intensity in the center and less intensity at the edge of the silicon wafer ensure a uniform temperature distribution, even under a time-variable temperature profile.

In addition to avoiding edge effects, beam shaping can be used for additional, targeted locally different heating profiles with predefined “hotter” and “colder” regions on the solar cell. (Example: interdigitated structures for contacting the front side of the solar cell).

The exemplary embodiment of FIG. 2 differs from that shown in FIG. 1 only in that the top side and the bottom side of each silicon wafer is not illuminated simultaneously over the entire surface, but successively by a moving line-shaped intensity distribution The optical means 5a, 5b are therefore designed somewhat differently so as to generate a more or less sharp line.

Advantageously, the movement of the interconnected holders 1 may be used to scan the line across the surfaces of silicon wafers. Disadvantageously though, less time is available for the time modulation of the laser light.

FIG. 3 shows two holders 1 connected by connecting means 2. Each of the holders 1 includes an upper frame 9 and a lower frame 10 made of a material that is transparent for the used laser wavelength. For example, quartz may be considered as a suitable material. The silicon wafer 11 to be heated is disposed between the two frames 9, 10.

FIGS. 4 and 5 show the silicon wafer 11 with a rectangular outline. The silicon wafer may, unlike in the diagram, also have a square outline.

The holder further includes two clamps 12, which press the frames 9, 10 against the silicon wafer 11 from above and from below. FIG. 4 shows that the damps 12 in each case project on the frame 9, 10 from the outside only far enough so that they protrude at most up to the edge 13 of the silicon wafer 11, but do not protrude beyond. In this way, the top side and the bottom side of the silicon wafer 11 can be illuminated with laser radiation 6a, 6b over the entire surface and thereby partially pass through the frame 9, 10.

An alternative embodiment is shown in FIG. 5. Plates 14, 15 without a central recess are hereby used instead of a circumferential frame 9, 10 with a central recess. Laser radiation 6a, 6b is here applied to the top side and the bottom side of the silicon wafer 11 exclusively by passing through the plates 14, 15.

1-17. (canceled)

18. A method for heat treatment of a wafer-shaped base material of a crystalline or polycrystalline silicon solar cell, comprising the steps of
providing a heat treatment with laser radiation (6a, 6b) of the crystalline or polycrystalline silicon.

19. The method according to claim 18, wherein the laser radiation (6a, 6b) is applied simultaneously to a top side and a bottom side of the base material.

20. The method according to claim 18, wherein the laser radiation (6a, 6b) comprises temporally structured pulses.

21. The method according to claim 18, wherein the laser radiation (6a, 6b) is simultaneously applied over the entire surface of the top side and/or the bottom side of the base material.

22. The method according to claim 18, wherein a line-shaped intensity distribution of the laser radiation (6a, 6b) moving successively over the entire surface is applied to the top side and/or the bottom side of the base material.

23. The method according to claim 18, wherein a first intensity of the laser radiation (6a, 6b) is applied in the center of the top and/or the bottom side of the base material and an intensity of less than the first intensity of the laser radiation (6a, 6b) is applied at the edge of the top and/or the bottom side of the base material.

24. The method according to claim 18, wherein a first laser radiation (6a) is applied to the top side of the base material and a second laser radiation (6b) is applied to the bottom side of the base material, and wherein the first and the second laser radiation (6a, 6b) differ from one another with respect to one or more properties so as to trigger different processes in the top side and bottom side of the base material.

25. An apparatus for heat treatment of a wafer-shaped base material of a crystalline or polycrystalline silicon solar cell solar cell, the apparatus comprising
at least one laser light source (4a, 4b) as a heat source.

26. The apparatus according to claim 25, further comprising
at least one holder (1) for the wafer-shaped base material.

27. The apparatus of claim 26, wherein the at least one holder (1) is at least partially in transparent the wavelength range of the laser radiation (6a, 6b).

28. The apparatus according to claim 26, wherein the at least one holder (1) is at least partially made of quartz.

29. The apparatus according to claim 26, wherein the at least one holder (1) comprises at least one frame (9) made of a material that is transparent in the wavelength range of the laser radiation (6a, 6b).

30. The apparatus according to claim 29, wherein the at least one holder (1) comprises two frames, and wherein the base material to be heated is supported between the two frames (9, 10).

31. The apparatus according to claim 26, wherein the at least one holder (1) comprises at least one plate (14) made of a material that is transparent in the wavelength range of the laser radiation (6a, 6b).

32. The apparatus of claim 31, wherein the base material to be heated is supported by the at least one plate (14).

33. The apparatus according to claims 26, wherein the at least one holder comprises a plurality of holders, which are connected to each other by connectors (2).

34. The apparatus according to claim 25, wherein the apparatus comprises optics means (5a, 5b) capable of applying the laser radiation (6a, 6b) emitted by the at least one laser light source (4a, 4b) to the top side and/or the bottom side of the base material.

35. The apparatus according to claim 26, wherein the at least one holder (1) comprises at least one frame (9) made of a material that is transparent in the wavelength range of the laser radiation (6a, 6b).

36. The apparatus according to claim 26, wherein the at least one holder (1) comprises at least one plate (14), made of a material that is transparent in the wavelength range of the laser radiation (6a, 6b).

37. The apparatus according to claim 31, wherein the at least one plate are two plates (14, 15).

38. The apparatus of claim 32, wherein the base material to be heated is supported by the two plate (14).

39. The apparatus according to claim 29, wherein the at least one frame comprises two frames (9, 10) made of a material that is transparent in the wavelength range of the laser radiation (6a, 6b).
